(19) United States
(12) Patent Application Publication
(10) Pub. No.: US 2020/0285584 A1
(43) Pub. Date: Sep. 10, 2020

(54) CACHE FLUSH ABORT CONTROLLER SYSTEM AND METHOD

(71) Applicant: QUALCOMM INCORPORATED, SAN DIEGO, CA (US)

(72) Inventors: Raghavendra Srinivas, Blacksburg, VA (US); Kaustav Roychowdhury, Bangalore (IN); Siddesh Halavarthi Math Revana, Bangalore (IN); Srivatsa Vaddagiri, Bangalore (IN); Satyaki Mukherjee, Hyderabad (IN)

(21) Appl. No.: 16/292,178

(22) Filed: Mar. 4, 2019

(51) Int. Cl. G06F 12/0891; G06F 12/0837; G06F 12/0842; G06F 12/0897

(52) U.S. Cl. CPC G06F 12/0891; G06F 12/0897; G06F 12/0842; G06F 12/0837

(57) ABSTRACT

Aborting a cache memory flush may include initiating a flush operation in which a plurality of cache lines are flushed from a cache memory associated with a processor core that is entering a power collapse mode. Assertion of a wake-up signal associated with the processor core entering the power collapse mode may be detected. The wake-up signal may occur before completion of the flush operation. The flush operation may cease or abort in response to detecting the wake-up signal.

### DESCRIPTION OF THE RELATED ART

Portable computing devices (“PCDs”) are becoming necessities for people on personal and professional levels. PCDs may include cellular telephones, portable digital assistants, portable game consoles, palmtop computers, and other portable electronic processing devices.

A PCD may have multiple processors or a multi-core processor. Scheduling techniques may be employed to distribute tasks among the cores in accordance with multi-tasking, multi-threading, and similar schemes. As a result of such distribution or scheduling techniques, one or more cores may be inactive or idle while one or more other cores are active. A core may be put into a low-power mode or “power collapse mode” if it remains idle for a relatively long time. The core remains in the power collapse mode until a wake-up event occurs. Wake-up events are generally asynchronous and unpredictable. A wake-up signal may be provided to a core in the form of an interrupt.

Commonly, once it is determined that a core is to enter a power collapse mode, the core's cache memory is flushed before the power supplied to the core is reduced or collapsed. For example, so-called “dirty” cache lines may be flushed one by one to a memory (which may be a system memory or a higher-level cache). If a wake-up signal (e.g., interrupt) occurs before the cache has completed flushing all of the dirty cache lines, the interrupt is withheld from the core until all dirty cache lines have been flushed. More specifically, before the flush begins, the interrupt interface to the core is disabled, and when the flush is completed the interrupt interface is re-enabled. When the interrupt interface is re-enabled, any pending wake-up interrupt is then delivered to the targeted core. As a cache flush is a time-intensive and power-intensive operation, judicious or intelligent algorithms may be used to determine whether it is beneficial in a particular instance to initiate the power collapse mode in a core.

### SUMMARY OF THE DISCLOSURE

Systems and method are disclosed for aborting a cache flush in a portable computing device (“PCD”).

An exemplary method for aborting a cache flush in a PCD may include initiating a flush operation. The flush operation may include flushing a plurality of cache lines from a cache memory associated with a processor core that is entering a power collapse mode. A wake-up signal associated with the processor core may be asserted before completion of the flush operation, and the method may further include detecting such a wake-up signal. The method may still further include ceasing the flush operation in response to detecting the wake-up signal. The flush operation ceases before the next cache line is flushed from the cache memory.

An exemplary system for aborting a cache flush in a PCD may include a processor core, a cache memory associated with the processor core, and a flush system. The flush system may be configured to control a flush operation. The flush operation relates to flushing a plurality of cache lines from the cache memory in response to the processor core entering a power collapse mode. A wake-up signal associated with the processor core may be asserted before completion of the flush operation, and the flush system may be further configured to detect such a wake-up signal. The flush system may be still further configured to cease the flush operation in response to detecting the wake-up signal. The flush operation cease before the next cache line is flushed from the cache memory.

Another exemplary system for aborting a cache flush in a PCD may include means for initiating a flush operation. The flush operation may include flushing a plurality of cache lines from a cache memory associated with a processor core that is entering a power collapse mode. A wake-up signal associated with the processor core may be asserted before completion of the flush operation, and the system may further include means for detecting such a wake-up signal. The system may still further include means for ceasing the flush operation in response to detecting the wake-up signal. The flush operation ceases before the next cache line is flushed from the cache memory.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a PCD, in accordance with exemplary embodiments.

FIG. 2 is block diagram illustrating software-related power control aspects of a multi-core-processor system, in accordance with exemplary embodiments.

FIG. 3 is block diagram of a portion of a system for aborting a cache flush, in accordance with exemplary embodiments.

FIG. 4 is a state diagram illustrating a method for aborting a cache flush, in accordance with exemplary embodiments.

FIG. 5A is a conceptual diagram of a cache memory before a flush operation.

FIG. 5B is similar to FIG. 5A, showing the cache memory when a flush operation is aborted.

FIG. 6 is a timing diagram illustrating a method of operation of the system of FIG. 3, in accordance with exemplary embodiments.

FIG. 7 is a flow diagram, illustrating a method for aborting a cache flush, in accordance with exemplary embodiments.

### DETAILED DESCRIPTION

The word “exemplary” is used herein to mean “serving as an example, instance, or illustration.” Any aspect described herein as “exemplary” is not necessarily to be construed as preferred or advantageous over other aspects.

The terms “central processing unit” (“CPU”), “digital signal processor” (“DSP”), and “graphics processing unit” (“GPU”) are non-limiting examples of processors that may reside in a PCD. These terms are used interchangeably herein except where otherwise indicated. A component, system, subsystem, module, etc., of the PCD may include and operate under the control of such a processor.

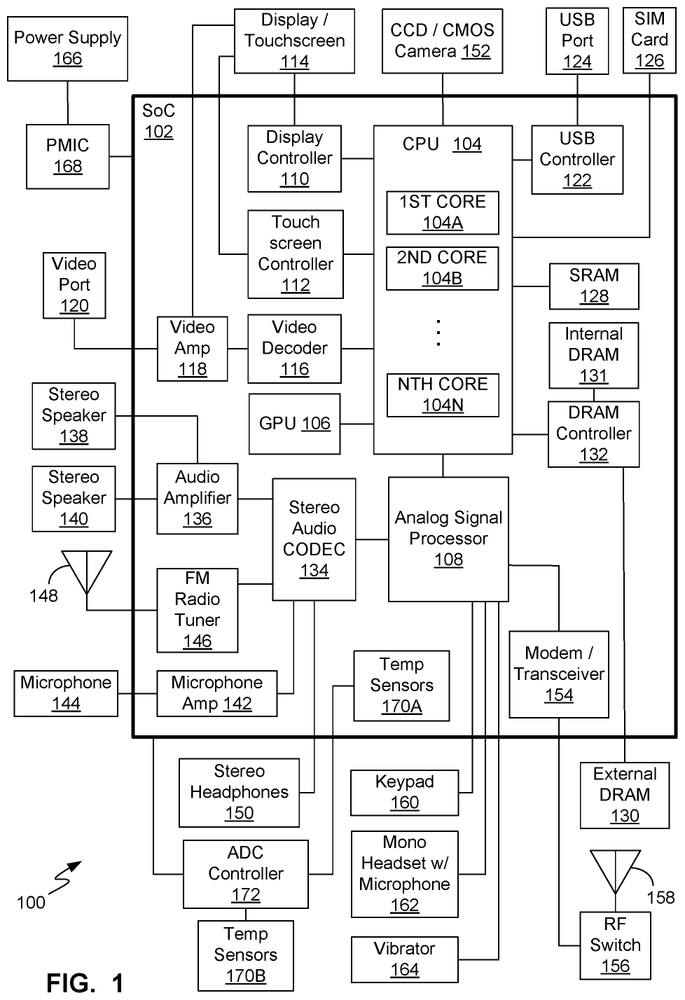

As illustrated in FIG. 1, illustrative or exemplary embodiments, systems and methods for aborting a cache memory flush may be embodied in a PCD 100. The PCD 100 includes a system on chip (“SoC”) 102, i.e., a system embodied in an integrated circuit chip. The SoC 102 may include a central processing unit (“CPU”) 104, a graphics processing unit (“GPU”) 106, or other processors. The CPU 104 may include multiple cores, such as a first core 104A, a second core 104B, etc., through an Nth core 104N. The SoC 102 may include an analog signal processor 108.

A display controller 110 and a touchscreen controller 112 may be coupled to the CPU 104. A touchscreen display 114 external to the SoC 102 may be coupled to the display controller 110 and the touchscreen controller 112. The PCD 100 may further include a video decoder 116. The video decoder 116 is coupled to the CPU 104. A video amplifier 118 may be coupled to the video decoder 116 and the touchscreen display 114. A video port 120 may be coupled to the video amplifier 118. A universal serial bus (“USB”) controller 122 may also be coupled to CPU 104, and a USB port 124 may be coupled to the USB controller 122. A subscriber identity module (“SIM”) card 126 may also be coupled to the CPU 104.

One or more memories may be coupled to the CPU 104. The one or more memories may include both volatile and non-volatile memories. Examples of volatile memories include static random access memory (“SRAM”) 128 and dynamic RAMs (“DRAM”s) 130 and 131. Such memories may be external to the SoC 102, such as the DRAM 130, or internal to the SoC 102, such as the DRAM 131. A DRAM controller 132 coupled to the CPU 104 may control the writing of data to, and reading of data from, the DRAMs 130 and 131. In other embodiments, such a DRAM controller may be included within a processor, such as the CPU 104.

A stereo audio CODEC 134 may be coupled to the analog signal processor 108. Further, an audio amplifier 136 may be coupled to the stereo audio CODEC 134. First and second stereo speakers 138 and 140, respectively, may be coupled to the audio amplifier 136. In addition, a microphone amplifier 142 may be coupled to the stereo audio CODEC 134, and a microphone 144 may be coupled to the microphone amplifier 142. A frequency modulation (“FM”) radio tuner 146 may be coupled to the stereo audio CODEC 134. An FM antenna 148 may be coupled to the FM radio tuner 146. Further, stereo headphones 150 may be coupled to the stereo audio CODEC 134. Other devices that may be coupled to the CPU 104 include a digital (e.g., CCD or CMOS) camera 152.

A modem or radio frequency (“RF”) transceiver 154 may be coupled to the analog signal processor 108. An RF switch 156 may be coupled to the RF transceiver 154 and an RF antenna 158. In addition, a keypad 160, a mono headset with a microphone 162, and a vibrator device 164 may be coupled to the analog signal processor 108.

A power supply 166 may be coupled to the SoC 102 via a power management integrated circuit (“PMIC”) 168. The power supply 166 may include a rechargeable battery or a DC power supply that is derived from an AC-to-DC transformer connected to an AC power source.

The SoC 102 may have one or more internal or on-chip thermal sensors 170A and may be coupled to one or more external or off-chip thermal sensors 170B. An analog-to-digital converter (“ADC”) controller 172 may convert voltage drops produced by the thermal sensors 170A and 170B to digital signals.

The touch screen display 114, the video port 120, the USB port 124, the camera 152, the first stereo speaker 138, the second stereo speaker 140, the microphone 144, the FM antenna 148, the stereo headphones 150, the RF switch 156, the RF antenna 158, the keypad 160, the mono headset 162, the vibrator 164, the thermal sensors 170B, the ADC controller 172, the PMIC 168, the power supply 166, the DRAM 130, and the SIM card 126 are external to the SoC 102 in this exemplary or illustrative embodiment. It will be understood, however, that in other embodiments one or more of these devices may be included in such an SoC.

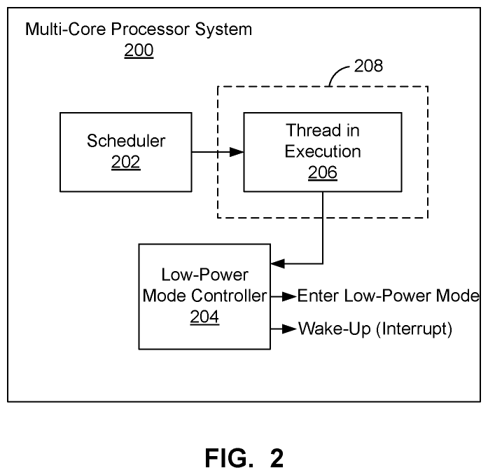

As illustrated in FIG. 2, a multi-core processing system 200 may include a scheduler 202 and a low-power mode controller 204. The scheduler 202 and low-power mode controller 204 may execute on one or more of the PCD processors or cores thereof described above with regard to FIG. 1. The scheduler 202 may distribute tasks among processor cores in accordance with multi-tasking, multi-threading, and similar schemes. As a result, a task or thread 206 may be executing on an exemplary core 208. The thread 206 may, for example, be an Idle thread that the scheduler 202 assigns to the core 208 when the core 208 would otherwise have no other thread (e.g., a thread relating to an application program) to execute. If the thread 206 determines that the amount of time it has been executing exceeds a threshold, the thread 206 may issue a request to the low-power mode controller 204 to place the core 208 into a low-power mode or power collapse mode. In response to such a request, the low-power mode controller 204 may signal the power control hardware (not shown in FIG. 2) to enter the core 208 into the power collapse mode. A sequence of actions may be undertaken within the power collapse mode, including initiating flushing of one or more cache memories (not shown in FIG. 2) as described below. Once such a flush operation has completed, one or more actions may be undertaken to reduce the power (i.e., voltage) supplied to the core 208. The core 208 may remain in the power collapse mode until a wake-up event occurs. The low-power mode controller 204 may issue such a wake-up signal in the form of an interrupt signal. It should be understood that the multi-core processing system 200 as shown in FIG. 2 is intended to broadly illustrate the principle of entry into a power collapse mode and that such a system may have any other suitable structure.

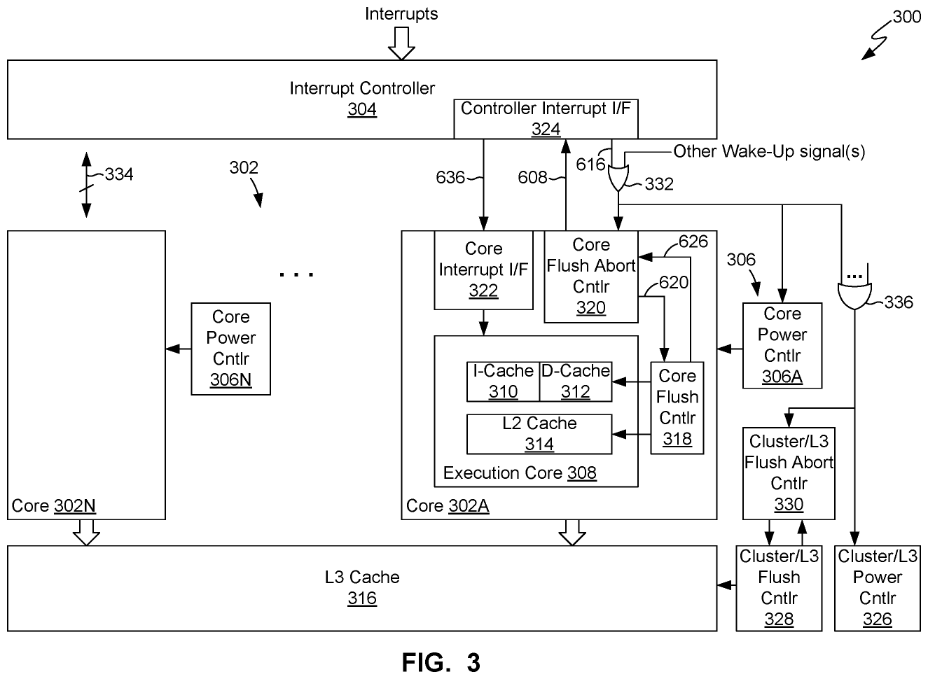

As illustrated in FIG. 3, a multi-core processing system 300 may include a plurality (N) of CPU cores 302, i.e., a first core 302A through an Nth core 302N, with the remaining cores 302 between the first core 302A and the Nth core 302N not shown in FIG. 3 for purposes of clarity but indicated by the ellipsis symbol (“ . . . ”). The cores 302 may be examples of the cores 104A-104N in FIG. 1. The plurality of cores 302 may also be referred to as a cluster of cores 302. The system 300 may also include an interrupt controller 304 that interfaces with each of the cores 302. The system 300 may further include a plurality (N) of core power controllers 306, i.e., a first core power controller 306A through an Nth core power controller 306N, each configured to control the power supplied to a corresponding one of the cores 302.

As illustrated in FIG. 3 by the first core 302A, each core 302 may include an execution core portion 308. Although not separately shown for purposes of clarity, the execution core portion 308 includes logic that executes instructions associated with the task or thread running on that core 302. The execution core portion 308 also includes one or more cache memories, such as an instruction cache 310 and a data cache 312. The instruction cache 310 and data cache 312 are commonly referred to as level-1 (“L1”) caches because they cache information used directly by the instruction execution logic. The execution core portion 308 may also include a level-2 (“L2”) cache 314 that caches information flushed from the L1 caches 310-312. The system 300 may also include a level-3 (“L3”) cache 316 that caches information flushed from the L2 caches of the cores 302.

Each core 302 may further include a core flush controller 318 that is configured to control a core-level flush operation. Depending upon operating conditions, and as well understood by one of ordinary skill in the art, such a flush operation may involve flushing information from one or both of the L1 caches 310 and 312 to L2 cache 314 or flushing information from the L2 cache 314 to the L3 cache 316. Each core 302 may further include a core flush abort controller 320 and a core interrupt interface 322. The core interrupt interface 322 interfaces with a corresponding controller interrupt interface 324 of the interrupt controller 304. It should be noted that although for purposes of clarity only the first core 302A is explicitly depicted in FIG. 1 as including the foregoing elements, all cores 302 may have the same structure and function in the same manner as each other.

The system 300 also includes an L3 or cluster power controller 326 that is configured to control the power supplied to the L3 cache 316 and associated elements. The system 300 further includes an L3 or cluster flush controller 328 that is configured to control a cluster-level flush operation. Such a cluster-level flush operation may involve flushing information from the L3 cache 316 to a system memory, such as the DRAM 130 or 131 shown in FIG. 1. Such a system memory may include a system cache (not shown). The system 300 still further includes an L3 or cluster flush abort controller 330. Although in this exemplary embodiment the system 300 includes three cache levels, L1, L2, and L3, the principles described herein relating to aborting a cache flush operation may be applied in other embodiments to a system having any other number of cache levels or system caches. Unless otherwise specified, the term “cache” or “cache memory” as used herein includes caches 310, 312, 314, and 316, as well as any other data cache, tag cache, system cache, or other cache memory.

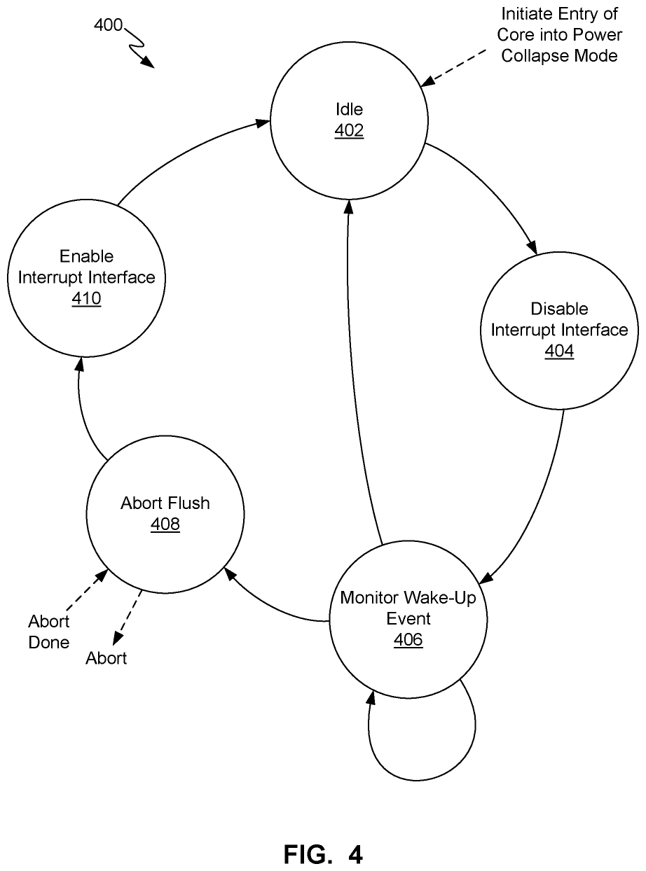

As illustrated in FIG. 4, a state diagram 400 illustrates that a flush operation, which may occur as a result of one of the cores 302 (FIG. 3) entering a power collapse mode, may be aborted if a wake-up event occurs before completion of the flush operation. Beginning in a first state 402, one of the cores 302 may be executing an Idle thread when an event occurs that initiates entry of that core 302 into the power collapse mode. A transition from the first state 402 to a second state 404 may occur in response to the core 302 entering the power collapse mode. That a core 302 is “entering” the power collapse mode does not necessarily mean that the power level supplied to the core 302 is immediately reduced or collapsed. Rather, that a core 302 is entering the power collapse mode means that a sequence of power collapse mode actions has been initiated, including initiating a flush operation. Normally, i.e., but for aborting the flush operation as described below, in the sequence of power collapse mode actions, the power level supplied to a core 302 and its associated caches is not collapsed until after completion of the flush operation.

In the second state 404 one or both (or portions thereof) of the core interrupt interface 322 or the controller interrupt interface 324 (FIG. 3) is disabled so that any wake-up or other interrupt signal from the interrupt controller 304 is prevented from reaching the core 302. Although in this exemplary embodiment the condition that prevents a wake-up interrupt signal from waking up the core 302 from the power collapse mode is a disabled interrupt interface between the interrupt controller 304 and the core 302, in other embodiments any other suitable condition may be imposed to prevent a wake-up signal from waking up a core. Once the interrupt interface is disabled, the flush operation may begin, and a transition from the second state 404 to a third state 406 may occur.

In the third state 406 the core flush abort controller 320 may monitor for a wake-up event while the cache memory (e.g., L1 cache 310 or 312, or L2 cache 314) associated with the core 302 entering the power-collapse mode is being flushed in the flush operation. Alternatively, or in addition, the cluster flush abort controller 330 may monitor for a wake-up event while the L3 cache 316 is being flushed in the flush operation. The loop in FIG. 4 from the third state 406 back to itself indicates such monitoring for a wake-up event. From the third state 406, a transition to the first state 402 may occur in response to completion of the flush operation. Also from the third state 406, a transition to a fourth state 408 may occur in response to detection of a wake-up event. That is, if the flush operation is completed before a wake-up event occurs, the transition from the third state 406 to the first state 402 occurs instead of the transition from the third state 406 to the fourth state 408. However, if a wake-up event occurs before the flush operation is completed, the transition from the third state 406 to the fourth state 408 occurs instead of the transition from the third state 406 to the first state 402.

In the fourth state 408 the flush operation may be aborted. As described in further detail below, initiating or controlling abortion of the flush operation may include the exchange of an Abort signal and an Abort Done or acknowledgement signal. A transition to a fifth state 410 may occur after the flush operation has been aborted.

In the fifth state 410 the condition preventing the wake-up event from waking up the core 302 is removed. For example, the interrupt interface or portion thereof that was disabled as described above with regard to the second state 404 may be re-enabled so that any wake-up or other interrupt signal from the interrupt controller 304 is allowed to reach the core 302. Then, a transition from the fifth state 410 back to the first state 402 may occur.

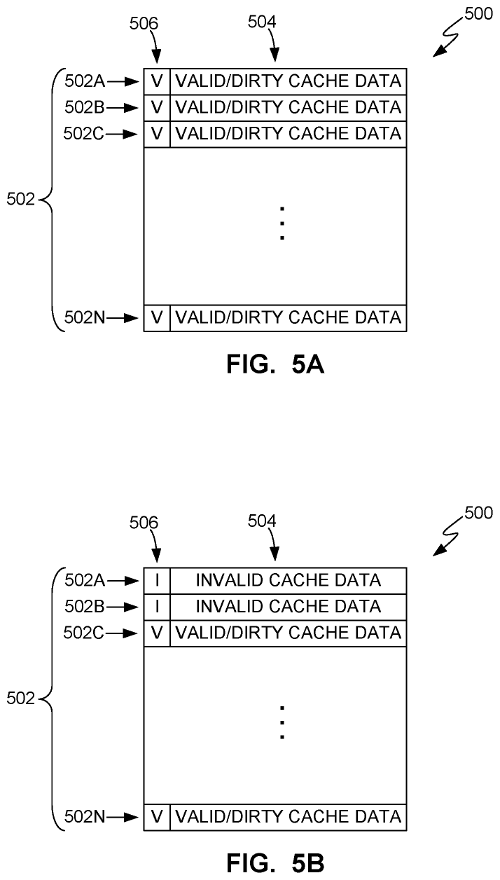

As illustrated in FIG. 5A, a cache memory 500 may include any number of cache lines 502A, 502B, 502C, etc., through 502N, which may be collectively referred to as cache lines 502. The cache memory 500 may be an example of any of the above-described caches 310, 312, 314, or 316. Each cache line 502 comprises a data portion 504 and a tag portion 506. In the exemplary instance of operation illustrated in FIG. 5A, the data portion 504 of each cache line 502 contains valid data, as indicated by the contents (“V”) of the corresponding tag portion 506. A cache line 502 containing valid data may also be referred to as a dirty cache line 502 or as containing dirty data. As understood by one of ordinary skill in the art, the term “dirty” refers to data that has not yet been copied (i.e., flushed) to a less transient storage location than the cache memory 500. During a flush operation, one or more cache lines 502 may have already been flushed at the time the flush operation is aborted, while one or more other cache lines 502 may remain dirty, i.e., not yet flushed. A “flush operation,” as that term is used herein, relates to flushing all flushable cache lines 502 of the cache memory 500. In an exemplary embodiment, the flushable cache lines 502 may be dirty cache lines. In such an embodiment, a flush operation relates to flushing all dirty cache lines 502. Nevertheless, in other embodiments some or all of the flushable cache lines, i.e., the cache lines indicated to be flushed in connection with a single flush operation, may be clean. In either case, absent aborting the flush operation, the flush operation is not completed until all flushable cache lines 502 of the cache memory 500 have been flushed.

For example, as illustrated in FIG. 5B, the data portion 504 of the cache line 502A may be flushed, and the contents of the corresponding tag portion 506 may then be updated to reflect that the data portion 504 is invalid (“I”) as a result. As understood by one of ordinary skill in the art, a cache line 502 tagged as invalid (or “clean”) is available for storing new data. After the data portion 504 of the cache line 502A is flushed and its tag portion 506 updated, the data portion 504 of the cache line 502B may be flushed and the contents of its tag portion 506 updated to reflect that the data portion 504 is invalid (“I”) as a result. However, in the illustrated example the flush operation is aborted after or approximately concurrently with the flushing of the cache line 502B but before the next dirty cache line 502C is flushed and before the next tag portion 506 is read. It should be understood that the term “next” as used herein in the context of flushing dirty cache lines 502 does not refer to adjacency of physical memory locations but rather relates to the sequence of dirty cache lines 502 to be flushed. So long as not all of the dirty cache lines 502 have been flushed at the time the flush operation is aborted, there is a “next” dirty cache line 502 to be flushed. As understood by one of ordinary skill in the art, dirty cache lines 502 may be interspersed with clean (invalid) cache lines 502 or otherwise physically arranged in the cache memory 500 in ways other than the exemplary arrangement shown in FIGS. 5A-5B. More generally, caches 310, 312, 314, and 316 may operate in accordance with caching principles well understood by one of ordinary skill in art. Accordingly, such conventional aspects are not described herein. Such conventional aspects may include providing a tag or other indication of which cache lines are flushable.

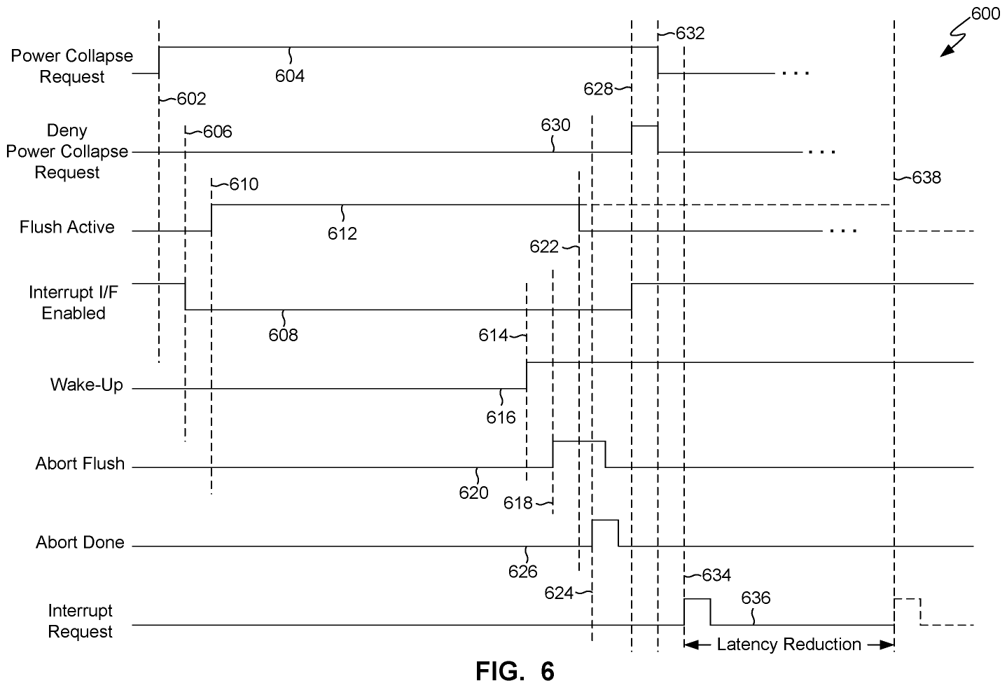

In FIG. 6, a timing diagram 600 (not to scale) illustrates an example of signals that may be involved in the operation of system 300 (FIG. 3). At a time 602, a Power Collapse Request signal 604 may be asserted. As described above with regard to FIG. 2, such a request may be issued to place one of the cores 302 (FIG. 3) into a low-power mode or power collapse mode. Although not explicitly shown in FIG. 3 for purposes of clarity, the Power Collapse Request signal 604 or a signal derived therefrom may be provided to the core power controller 306 controlling the power supplied to the core 302 being requested to enter the power collapse mode. That core power controller 306 may convey the request to the core 302.

In response to the request for the core 302 to enter the power collapse mode, the core flush controller 318 may initiate a flush operation. However, prior to the dirty data being flushed, the core flush abort controller 320 may (e.g., at a time 606) de-assert an Interrupt Interface Enabled signal 608 that is provided to the controller interrupt interface 324 (FIG. 3). In response to de-assertion of the Interrupt Interface Enabled signal 608, the controller interrupt interface 324 may refrain from providing interrupt request signals to the core interrupt interface 322. In other words, the interface function between the controller interrupt interface 324 and the core interrupt interface 320 is disabled in response to the request for the core 302 to enter the power collapse mode.

At a time 610, following disabling of the interface function between the controller interrupt interface 324 and the core interrupt interface 322, the core flush controller 318 may begin controlling the flushing of dirty data from the L1 caches 310 and 312 or the L2 cache 314, as indicated by the Flush Active signal 612. In accordance with the flush operation, dirty cache lines may be flushed from the L1 caches 310-312 to the L2 cache 314 or from the L2 cache 314 to the L3 cache 316.

At a time 614, which is before the flush operation has completed, a Wake-Up event signal 616 may be asserted in, for example, the manner described above with regard to FIG. 2. The Wake-Up event signal 616 may be provided by the controller interrupt interface 324 to the core flush abort controller 320. For example, the Wake-Up event signal 616 may be provided to the core flush abort controller 320 via an OR gate 332 (FIG. 3). Signals generated by other elements of the PCD 100 (FIG. 1) that may be intended to similarly have an effect of waking up the core 302 from a power collapse mode may be provided to other inputs of the OR gate 332. Although not shown in this example, but for the disabled condition or state of the interrupt interface (beginning at time 606), a (wake-up) interrupt request would be delivered to the core interrupt interface 322.

At a time 618, the core flush abort controller 320 may assert an Abort Flush signal 620 in response to the Wake-Up event signal 616. In response to the Abort Flush signal 620, the core flush controller 318 may abort the flush operation, i.e., refrain from flushing the next dirty cache line of the one or more dirty cache lines remaining to be flushed in the current flush operation, as indicated by the transition of the Flush Active signal 612 to the inactive state at time 622.

At a time 624, the core flush controller 318 may assert an Abort Done signal 626 to indicate to the core flush abort controller 320 that the flushing of dirty cache lines has ceased (i.e., before the next dirty cache line has been flushed). Although such an instance is not depicted in FIG. 6, if no more dirty cache lines remain to be flushed in the current flush operation at the time the core flush controller 318 receives the Abort Flush signal 620, the core flush controller 318 would not assert the Abort Done signal 626. The Abort Flush signal 620 and Abort Done signal 626 constitute a handshake that ensures aborting occurs at an individual cache line level of granularity.

At a time 628, with the flush operation having been aborted, the core flush abort controller 320 may then re-assert the Interrupt Interface Enabled signal 608. The re-enabling of the Interrupt Interface Enabled signal 608 removes the condition that caused the controller interrupt interface 324 to block or otherwise refrain from delivering an interrupt request to the core interrupt interface 322.

At or about the same time 628, and also in response to the flush operation having been aborted, the core flush abort controller 320 may assert a Deny Power Collapse Request signal 630. In response to the Deny Power Collapse Request signal 630, the core power controller 306 may terminate the above-described sequence of actions that is undertaken within the power collapse mode, and which normally (i.e., but for aborting the flush operation) begins with initiating the flush operation and ends with reducing or collapsing the supplied power. Thus, although the flush operation has ceased (as indicated by the de-assertion of the Flush Active signal 612 at time 622), the supplied power is not collapsed as it would have been if the flush operation had been completed. At a time 632, the Power Collapse Request signal 604 may be de-asserted in response to the above-mentioned assertion of the Deny Power Collapse Request signal 630. Note that in an instance (not shown) in which the flush operation is not aborted but rather is completed, the Deny Power Collapse Request signal 630 would not be asserted, and the power supplied to the core 302 would be reduced or collapsed at some time following de-assertion of the Flush Active signal 612.

At a time 634, following the re-enabling of the interrupt interface at time 628, an indication of the wake-up event that had been withheld by the controller interrupt interface 324 is delivered to the core interrupt interface 322 in the form of a (wake-up) Interrupt Request signal 636. That is, the re-enabling of the interrupt interface removed the condition preventing the wake-up event from waking up the core 302 from the power collapse mode sequence.

Referring again to FIG. 3, in the same manner that the group of signals 608, 616, and 636 serves the interrupt interface between the interrupt controller 304 and the first core 302A, a similar group of signals 334 may serve a similar interface between the interrupt controller 304 and the Nth core 302N, etc. More generally, the same operations and interface described above apply to each of the cores 302A-302N.

Also, it should be noted that the wake-up signal associated with any core 302 is provided to the cluster power controller 326 and the cluster flush abort controller 330 via an OR gate 336. In this manner, waking up any one or more of cores 302 also has the effect of aborting any flush of the L3 cache 316 that may be in progress (i.e., not completed) at the time a flush operation of the L1 or L2 caches 310-314 is aborted. The same operations described above with regard to aborting a flush operation involving the L1 or L2 caches 310-314 are applicable to aborting a flush operation involving the L3 cache 316, such as the above-described handshake operation. In the case of aborting a cluster-level flush operation, the handshake would occur between the cluster flush controller 328 and the cluster flush abort controller 330.

Referring again to FIG. 6, in an alternative instance or example, in which the flush operation is not aborted, the flush operation may be completed at a time 638, as indicated by the continuation of the Flush Active signal 612 in broken line. As also indicated in broken line, in such an instance the (wake-up) Interrupt Request signal 636 would reach the core 302 at or about time 638. Note that the method described herein for aborting a cache memory flush operation provides a latency reduction equal to the timespan between times 634 and 638. But for the capability of aborting a cache memory flush operation as described herein, a wake-up event would be ignored until after the flush operation had completed.

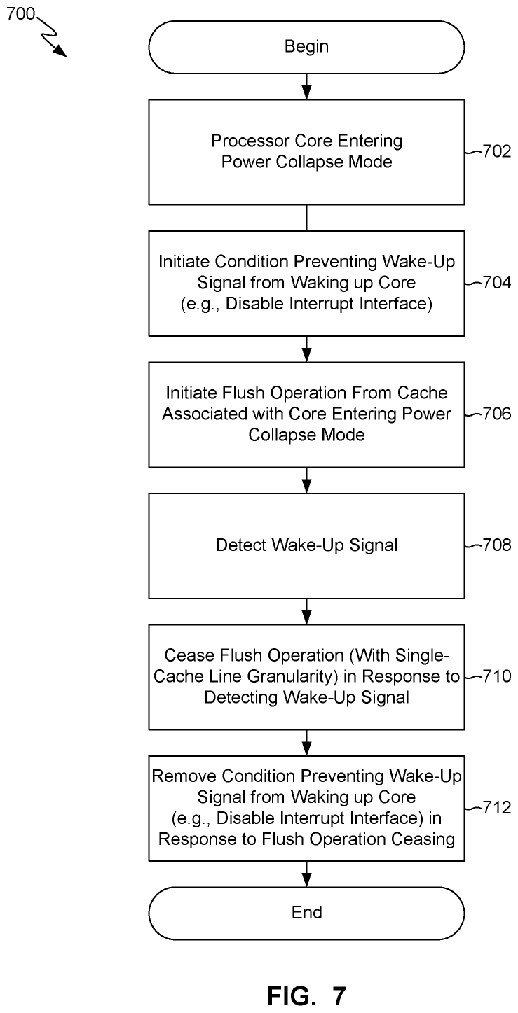

As illustrated in FIG. 7, a method 700 for aborting a cache flush in a PCD may begin with a processor core entering a power collapse mode, as indicated by block 702. Then, before the power supplied to the core is collapsed, and before a flush operation is begun on a cache memory associated with the core, a condition may be initiated to prevent any wake-up signal that occurs before completion of the flush operation from waking up the core from the power collapse mode, as indicated by block 704. For example, an interrupt interface function may be disabled. Once the condition is in place to prevent any wake-up signal that occurs before completion of the flush operation from waking up the core, the flush operation may be initiated to begin flushing dirty cache lines from the cache memory associated with the core, as indicated by block 706. As indicated by block 708, at any time during the flush operation, i.e., before the flush operation is completed, a wake-up signal associated with the core may be detected. As indicated by block 710, the method 700 may include ceasing the flush operation in response to detecting such a wake-up signal. More specifically, the flush operation ceases before the next dirty cache line is flushed from the cache memory. As indicated by block 710, the condition preventing the wake-up signal from waking up the core from the power collapse mode is then removed in response to the flush operation ceasing. For example, an interrupt interface function that was disabled may be re-enabled. With the condition removed, any pending wake-up signal that was detected may then wake up the core.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for cache memory flushing in a multi-core processing system, comprising:
initiating a flush operation, the flush operation comprising flushing a plurality of cache lines from a cache memory associated with a processor core entering a power collapse mode to another memory;
detecting a wake-up signal associated with the processor core before completion of the flush operation; and
in response to detecting the wake-up signal before completion of the flush operation, ceasing the flush operation before a next cache line of the plurality of cache lines is flushed from the cache memory.

2. The method of claim 1, further comprising:
initiating, before any cache lines are flushed in the flush operation, a condition preventing the wake-up signal from waking up the processor core from the power collapse mode; and
in response to the flush operation ceasing before the next cache line is flushed, removing the condition preventing the wake-up signal from waking up the processor core from the power collapse mode.

3. The method of claim 2, wherein:
initiating the condition comprises disabling an interrupt interface to the processor core; and
removing the condition comprises re-enabling the interrupt interface.

4. The method of claim 2, wherein:
ceasing the flush operation comprises generating an abort request signal in response to the wake-up signal and initiating, by an abort controller in response to the abort request signal, termination of the flush operation; and
removing the condition comprises monitoring for receipt of an abort acknowledgement signal from a flush controller, the abort acknowledgement signal indicating the flush operation has ceased before a next cache line of the plurality of cache lines has been flushed, and removing the condition in response to receipt of the abort acknowledgement signal.

5. The method of claim 1, wherein the processor core is one of a plurality of processor cores, the cache memory is one of a plurality of level-1 cache memories, each associated with one of the processor cores, and the flush operation is configured to flush a plurality of dirty cache lines from the cache memory to a level-2 cache memory associated with the processor core.

6. The method of claim 1, wherein the processor core is one of a plurality of processor cores, the cache memory is one of a plurality of level-2 cache memories, each associated with one of the processor cores, and the flush operation is configured to flush a plurality of dirty cache lines from the cache memory to a level-3 cache memory associated with the processor core.

7. The method of claim 1, wherein the processor core is one of a plurality of processor cores, the cache memory is a level-3 cache memory associated with all of the processor cores, and the flush operation is configured to flush a plurality of dirty cache lines from the cache memory to a system memory.

8. The method of claim 1, wherein the cache memory and the processor core are included in a portable computing device (“PCD”).

9. A system for aborting a cache memory flush in a multi-core processing system, comprising:
a processor core;
a cache memory associated with the processor core; and
a flush system configured to control a flush operation to flush a plurality of dirty cache lines from the cache memory to another memory in response to the processor core entering a power collapse mode, the flush system further configured to detect a wake-up signal associated with the processor core before completion of the flush operation, the flush system still further configured to cease the flush operation, in response to detecting the wake-up signal before completion of the flush operation, before a next dirty cache line of the plurality of cache lines is flushed from the cache memory.

10. The system of claim 9, wherein the flush system comprises:
a flush controller configured to flush the plurality of cache lines from a cache memory to another memory in response to the processor core entering the power collapse mode; and
a flush abort controller configured to detect the wake-up signal before completion of the flush operation and to initiate, before any cache lines are flushed in the flush operation, a condition preventing the wake-up signal from waking up the processor core from the power collapse mode, the flush abort controller further configured to cause the flush operation to cease before a next cache line of the plurality of cache lines is flushed from the cache memory and to remove, in response to the flush operation ceasing before the next cache line is flushed, the condition preventing the wake-up signal from waking up the processor core from the power collapse mode.

11. The system of claim 10, wherein the flush abort controller is configured to initiate the condition by disabling an interrupt interface to the processor core and to remove the condition by re-enabling the interrupt interface.

12. The system of claim 10, wherein the flush abort controller is configured to generate an abort request signal in response to the wake-up signal and initiate termination of the flush operation in response to the abort request signal, the flush abort controller is further configured to monitor for receipt of an abort acknowledgement signal from the flush controller, the abort acknowledgement signal indicating the flush operation has ceased before a next cache line of the plurality of cache lines has been flushed, and the flush abort controller is still further configured to remove the condition in response to receipt of the abort acknowledgement signal.

13. The system of claim 9, wherein the processor core is one of a plurality of processor cores, the cache memory is one of a plurality of level-1 cache memories, each associated with one of the processor cores, and the flush operation is configured to flush a plurality of cache lines from the cache memory to a level-2 cache memory associated with the processor core.

14. The system of claim 9, wherein the processor core is one of a plurality of processor cores, the cache memory is one of a plurality of level-2 cache memories, each associated with one of the processor cores, and the flush operation is configured to flush a plurality of cache lines from the cache memory to a level-3 cache memory associated with the processor core.

15. The system of claim 9, wherein the processor core is one of a plurality of processor cores, the cache memory is a level-3 cache memory associated with all of the processor cores, and the flush operation is configured to flush a plurality of cache lines from the cache memory to a system memory.

16. The system of claim 9, wherein the plurality of processor cores, the plurality of cache memories, and the flush system are included in a portable computing device (“PCD”).

17. A system for aborting a cache memory flush in a multi-core processing system, comprising:
a plurality of processor cores, each having an associated level-1 cache memory; and
a flush system comprising:
a plurality of core-level flush controllers, each core-level flush controller associated with one of the processor cores and configured to control a flush operation to flush the plurality of cache lines from a core-level cache memory to another memory in response to an associated processor core entering the power collapse mode;
a plurality of core-level flush abort controllers, each core-level flush abort controller associated with one of the processor cores and configured to detect a wake-up signal before completion of the flush operation and to initiate, before any cache lines are flushed in the flush operation, a condition preventing the wake-up signal from waking up the associated processor core from the power collapse mode, the core-level flush abort controller further configured to cause the flush operation to cease before a next cache line of the plurality of cache lines is flushed from the core-level cache memory and to remove, in response to the flush operation ceasing before the next cache line is flushed, the condition preventing the wake-up signal from waking up the associated processor core from the power collapse mode.

18. The system of claim 17, further comprising:
a cluster-level cache memory associated with all of the processor cores;
a cluster-level flush controller associated with one of the processor cores and configured to control a cluster-level flush operation to flush the cluster-level cache memory to a system memory; and
a cluster-level flush abort controller configured to cause the cluster-level flush operation to cease in response to detecting the wake-up signal associated with any processor core.

19. The system of claim 18, wherein the cluster-level cache memory is selected from the group consisting of level-1 and level-2.

20. The system of claim 18, wherein each core-level flush abort controller is configured to initiate the condition by disabling an interrupt interface to the processor core and to remove the condition by re-enabling the interrupt interface.

21. The system of claim 18, wherein the cluster-level flush abort controller is configured to generate a cluster-level abort request signal in response to detection of the wake-up signal associated with any processor core and initiate termination of the cluster-level flush operation in response to the cluster-level abort request signal, the cluster-level flush abort controller is further configured to monitor for receipt of a cluster-level abort acknowledgement signal from the cluster-level flush controller, the cluster-level abort acknowledgement signal indicating the cluster-level flush operation has ceased.

22. The system of claim 17, wherein the plurality of processor cores, the plurality of cache memories, and the flush system are included in a portable computing device (“PCD”).

23. A system for cache memory flushing in a multi-core processing system, comprising:
means for initiating a flush operation comprising flushing a plurality of cache lines from a cache memory associated with a processor core entering a power collapse mode to another memory;
means for detecting a wake-up signal associated with the processor core before completion of the flush operation; and
means for, in response to detecting the wake-up signal before completion of the flush operation, ceasing the flush operation before a next cache line of the plurality of cache lines is flushed from the cache memory.

24. The system of claim 23, further comprising:
means for initiating, before any cache lines are flushed in the flush operation, a condition preventing the wake-up signal from waking up the processor core from the power collapse mode; and
means for, in response to the flush operation ceasing before the next cache line is flushed, removing the condition preventing the wake-up signal from waking up the processor core from the power collapse mode.

25. The system of claim 24, wherein:
the means for initiating the condition comprises disabling an interrupt interface to the processor core; and
the means for removing the condition comprises re-enabling the interrupt interface.

26. The system of claim 24, wherein:
the means for ceasing the flush operation comprises means for generating an abort request signal in response to the wake-up signal and for initiating, by an abort controller in response to the abort request signal, termination of the flush operation; and
the means for removing the condition comprises means for monitoring for receipt of an abort acknowledgement signal from a flush controller, the abort acknowledgement signal indicating the flush operation has ceased before a next cache line of the plurality of cache lines has been flushed, and for removing the condition in response to receipt of the abort acknowledgement signal.

27. The system of claim 23, wherein the processor core is one of a plurality of processor cores, the cache memory is one of a plurality of level-1 cache memories, each associated with one of the processor cores, and the flush operation is configured to flush a plurality of cache lines from the cache memory to a level-2 cache memory associated with the processor core.

28. The system of claim 23, wherein the processor core is one of a plurality of processor cores, the cache memory is one of a plurality of level-2 cache memories, each associated with one of the processor cores, and the flush operation is configured to flush a plurality of cache lines from the cache memory to a level-3 cache memory associated with the processor core.

29. The system of claim 23, wherein the processor core is one of a plurality of processor cores, the cache memory is a level-3 cache memory associated with all of the processor cores, and the flush operation is configured to flush a plurality of cache lines from the cache memory to a system memory.

30. The system of claim 23, wherein the plurality of processor cores, the plurality of cache memories, and the flush system are included in a portable computing device (“PCD”).
